(19) United States
(12) Patent Application Publication
(10) Pub. No.: US 2002/0118664 A1
(43) Pub. Date: Aug. 29, 2002

(54) Communication setup method and electronic device

(75) Inventors: Yasuhiro Ishibashi, Tokyo (JP); Takero Kobayashi, Minato-ku (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/078,726

(22) Filed: Feb. 19, 2002

(30) Foreign Application Priority Data
Feb. 23, 2001 (JP) 2001-048004

(51) Int. Cl. H04Q 7/24

(52) U.S. Cl. 370/338; 370/349

(57) ABSTRACT

Network setups for a plurality of wireless devices are registered together with their priority order, and a connection request is output based on the priority order. If a response signal to the output connection request cannot be received, a connection request is output to the wireless device with the second highest priority. When a response signal to the connection request can be received, an authentication process is performed with that wireless device, and a network setup with the wireless device is established. When a communication with that wireless device is disabled, the aforementioned process is executed again to detect a device with which communication connection can be established.

### CROSS-REFERENCE TO RELATED APPLICATIONS

This application is based upon and claims the benefit of priority from the prior Japanese Patent Application No. 2001-048004, filed Feb. 23, 2001, the entire contents of which are incorporated herein by reference.

### BACKGROUND OF THE INVENTION

1. Field of the Invention

The present invention relates to a network setup method for exchanging data using wireless communications, and an electronic device using the method.

2. Description of the Related Art

Conventionally, a network is prevalently built using a plurality of personal computers (to be referred to as PCs hereinafter) at home, office, or other locations so as to use resources such as other PCs connected to the network. A network is designed to allow use of a network environment at each location even when a portable PC such as a notebook type PC or the like is moved to various locations, so that a network server, printer, and the like in that network can be used by the portable PC.

In such an environment, various setups are required for various respective locations in order to allow use of the network at those locations.

For example, when the user wants to use various network environments with a single notebook type PC, he or she must change the setups of a LAN (Local Area Network), change the cable connection of a modem, or must replace a PC card with a different one. In order to enable setups after such changes, the PC must often be restarted.

The user must also change network environment setups when the PC employs a wireless LAN, Bluetooth, or the like, which have rapidly become prevalent in recent years.

However, Jpn. Pat. Appln. KOKAI Publication No. 10-117207 discloses a mobile terminal connection method for establishing a data communication channel between a portable terminal at an arbitrary location and a PC connected to a network which comprises the portable terminal and a router.

However, in the prior art, when the PC has moved, and the connection environment to the network has changed, the user must manually set the network environment.

In the technique disclosed in Jpn. Pat. Appln. KOKAI Publication No. 10-117207, the router of the network establishes a communication channel of the portable terminal, and connection setups cannot be made from the portable terminal that the user carries. Hence, if no router is available at a given destination, the user must manually change setups.

### BRIEF SUMMARY OF THE INVENTION

Embodiments of the present invention provide a communication setup method and electronic device, which implement transition to a different network environment using an electronic device such as a notebook type PC employing wireless communications such as a wireless LAN, Bluetooth, or the like.

According to embodiments of the present invention, a communication setup method for an electronic device employing wireless communications is described.

According to one embodiment, a first connection request signal based on a connection setup with a first wireless communication device is output via wireless communications. A second connection request signal based on a connection setup with a second wireless communication device is output via wireless communications when a response signal to the first connection request signal cannot be received. A wireless communication is established with the second wireless communication device based on a first communication setup when a response signal to the second connection request signal is received. According to another embodiment, a beacon frame is acquired via wireless communications. Information of the beacon frame is compared with connection setups of a plurality of wireless communication devices. Wireless communication is established with at least one of the plurality of wireless communication devices based on a communication setup when the information of the beacon frame matches at least one of the connection setups of the plurality of wireless communication devices.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the hardware arrangement of an electronic device according to the present invention;

FIG. 2 is a diagram showing an example of the network arrangement upon using the electronic device according to the present invention;

FIG. 3 is a flow chart showing a network detection process according to a first embodiment;

FIG. 4 shows an access point list stored in a mobile PC;

FIG. 5 shows a wireless LAN setup item list in accordance with an access point;

FIG. 6 shows a network setup item list in accordance with an access point;

FIG. 7 shows an application setup item list in accordance with a network;

FIG. 8 shows the packet structure of a Probe request packet;

FIG. 9 shows the packet structure of a Probe response packet;

FIG. 10 shows the packet structure of a Beacon frame; and

FIG. 11 is a flow chart showing a network detection process according to a second embodiment.

### DETAILED DESCRIPTION OF THE INVENTION

Preferred embodiments according to the present invention will be described hereinafter with reference to the accompanying drawings.

A portable electronic device (to be referred to as a mobile PC hereinafter) according to the present invention comprises an interface for making wireless communications (wireless I/F). The present invention uses the IEEE802.11b system (to be simply referred to as 802.11 hereinafter) as the wireless I/F. In this 802.11, wireless communications are made using the 2.4-GHz band called an ISM (Industrial Scientific Medical) band, and a direct sequence spread spectrum (DSSS) scheme is used as a modulation scheme of transmission/reception signals.

In 802.11, the 2.4-GHz band (2.4000 to 2.4835 GHz) are split into 14 channels in practical use (channels that can be used are limited in some countries). The band occupied by each channel is ±11 MHz from the center frequency of each channel, i.e., 22 MHz. This communication channel is set to use an identical channel between devices which make wireless communications.

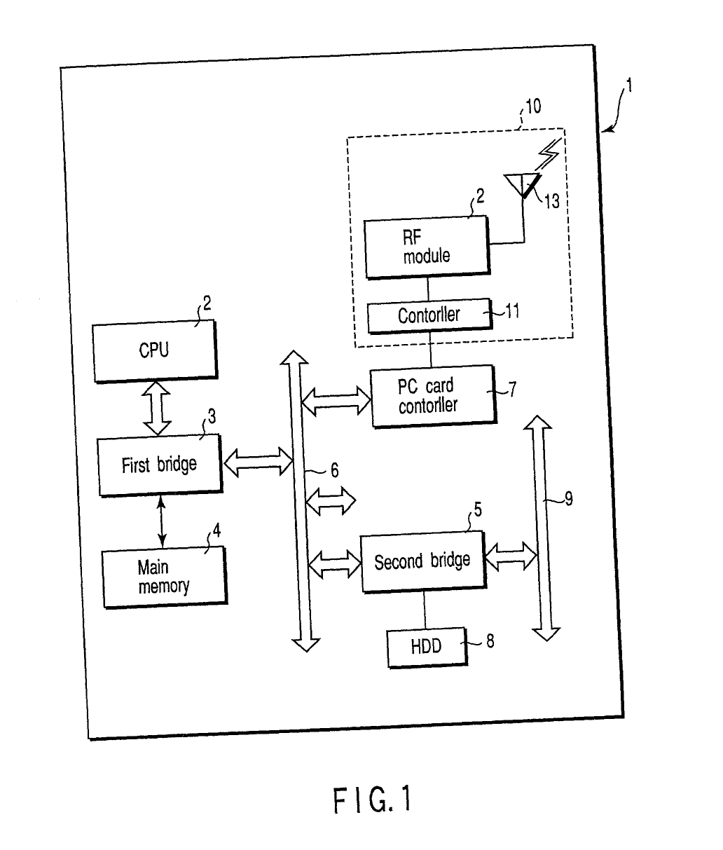

FIG. 1 shows the hardware arrangement of an electronic device according to the present invention. As an electronic device according to the present invention, a portable PC such as a notebook type PC, laptop type PC, and the like (to be referred to as a mobile PC hereinafter) is assumed.

In the main body of a mobile PC 1, a CPU 2 that controls the mobile PC 1 and a first bridge 3 are connected via a CPU local bus having a 64-bit wide data bus, and the first bridge 3 and a main memory 4 are also connected via a CPU local bus. The first bridge 3 and a second bridge 5 are connected via a first bus 6. A PC card controller 7 is connected to the first bus 6. An HDD 8 is connected to the second bridge 5, and various devices are connected to a second bus 9 connected to the second bridge 5.

The CPU 2 executes operation control, data processes, and the like of the entire mobile PC 1.

The main memory 4 is a memory device that stores an operating system, device drivers, application programs to be executed, processing data, and the like, and comprises a plurality of DRAMs and the like. The main memory 4 may also store an 802.11 wireless communication driver, and a network detection program according to an embodiment of the present invention. The mobile PC 1 operates when the CPU 2 executes a program stored in the main memory 4.

The first bridge 3 is a bridge LSI which serves as one of bus master devices of the first bus 6. The first bridge 3 has a function of converting the bus width including those of data and address buses between the CPU 2 and devices connected to the first bus 6, a function of controlling access to the main memory 4, and the like.

The first bus 6 is a clock synchronous I/O bus, and has an address/data bus which is used time-divisionally.

The PC card controller 7 is connected to the first bus 6, and a wireless PC card 10 is connected to the PC card controller 7.

The PC card controller 7 is an interface with a PC card type expansion module or the like connected to the mobile PC 1, and exchanges data with the PC card.

The wireless PC card 10 has a controller 11, RF module 12, and antenna 13, which are connected via a dedicated bus.

The controller 11 executes, e.g., baseband control (wireless interface control) for making wireless communications complying with the IEEE802.11b protocol, and exchanges data with the PC card controller 7. Also, the controller 11 checks the reception level (field strength) of a signal.

The RF module 12 performs A/D conversion, D/A conversion, and the like of a signal to make wireless communications of data, and is connected to the antenna 13.

The antenna 13 radiates as a radio wave an analog signal which has been converted by the RF module 12. Also, the antenna 13 receives an analog signal, and sends it to the RF module 12 for conversion.

The second bridge 5 is a bridge LSI which bridges between the first and second buses 6 and 9, and executes bus conversion and the like between the first and second buses 6 and 9. The HDD 8 which is also used as a data storage/reproduction device is connected to the second bridge 5, which includes an IDE controller for controlling the HDD 8.

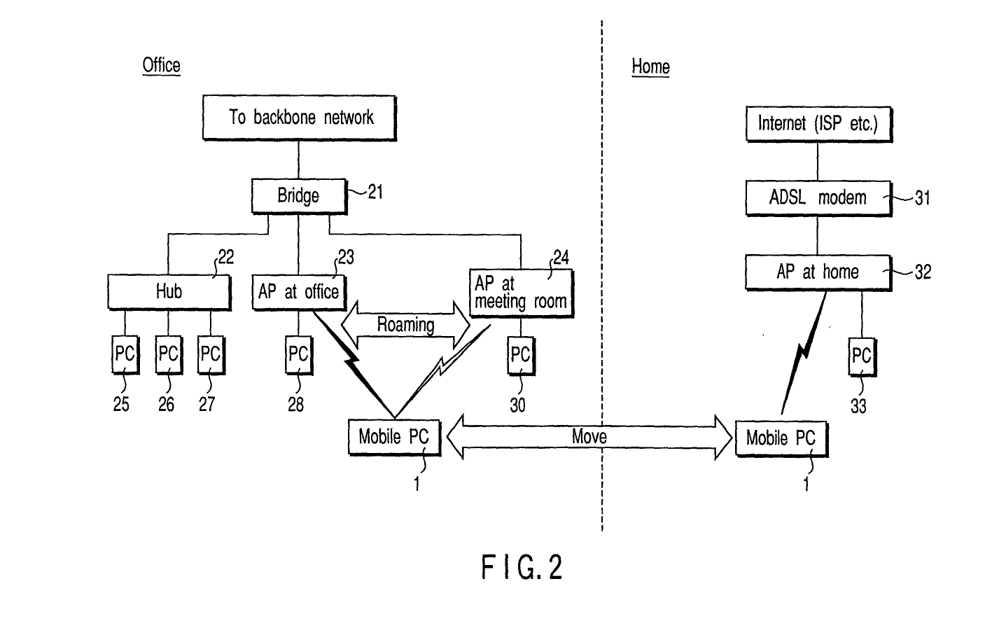

FIG. 2 shows an example of a network arrangement in which embodiments of the present invention may be employed.

In FIG. 2, a system on the left side of the dotted line is a network which assumes an office of, e.g., a company, and that on the right side of the dotted line is a network at home.

At the office, a bridge 21 is connected to a backbone network, and a hub 22 and access points 23 and 24 are connected to this bridge 21.

The bridge 21 has a function of transferring communication data received from the hub 22 and access points 23 and 24 to appropriate communication partners. Also, the bridge 21 has a function of sending communication data, which is sent from the backbone network to PC terminals, to appropriate terminals.

The hub 22 comprises a wired LAN interface, and has a function of transferring communication data sent from PCs 25, 26, and 27, which are connected via a wired LAN, to appropriate communication partners.

The access point 23 is a wireless LAN access point equipped at the office of the company, and has wired and wireless LAN interfaces. The access point 23 also has a bridge function of transferring communication data among a PC 28 connected via a wired LAN, the bridge 21, and the mobile PC 1 connected via a wireless LAN to appropriate communication partners.

The access point 24 is a wireless LAN access point equipped at a meeting room of the office. The access point 24 also has a bridge function of transferring communication data among a PC 30 connected via a wired LAN, the bridge 21, and the mobile PC 1 connected via a wireless LAN to appropriate communication partners, similarly to the access point 23.

An example of the network arrangement at home will be explained below using the right side of FIG. 2.

An ADSL modem 31 is used to establish ADSL (Asymmetric Digital Subscriber Line) connection between a home LAN and external WAN (Wide Area Network). The ADSL modem 31 is connected to a wireless LAN access point 32 equipped at home via a wired LAN.

The wireless LAN access point 32 has a wired LAN interface connected to a PC 33, and a wireless LAN interface connected to the mobile PC 1 via a wireless LAN, serves as a bridge between these interfaces, and also serves as a router between a wired LAN port that connects the ADSL modem 31 and the bridge function.

The PC 33 is a home PC connected to the access point 32 via a wired LAN.

The mobile PC 1 is connected to an access point 32 at home, is connected to the access point 23 at the office or the access point 24 at the meeting room, and is connected to the backbone network in the company via these access points.

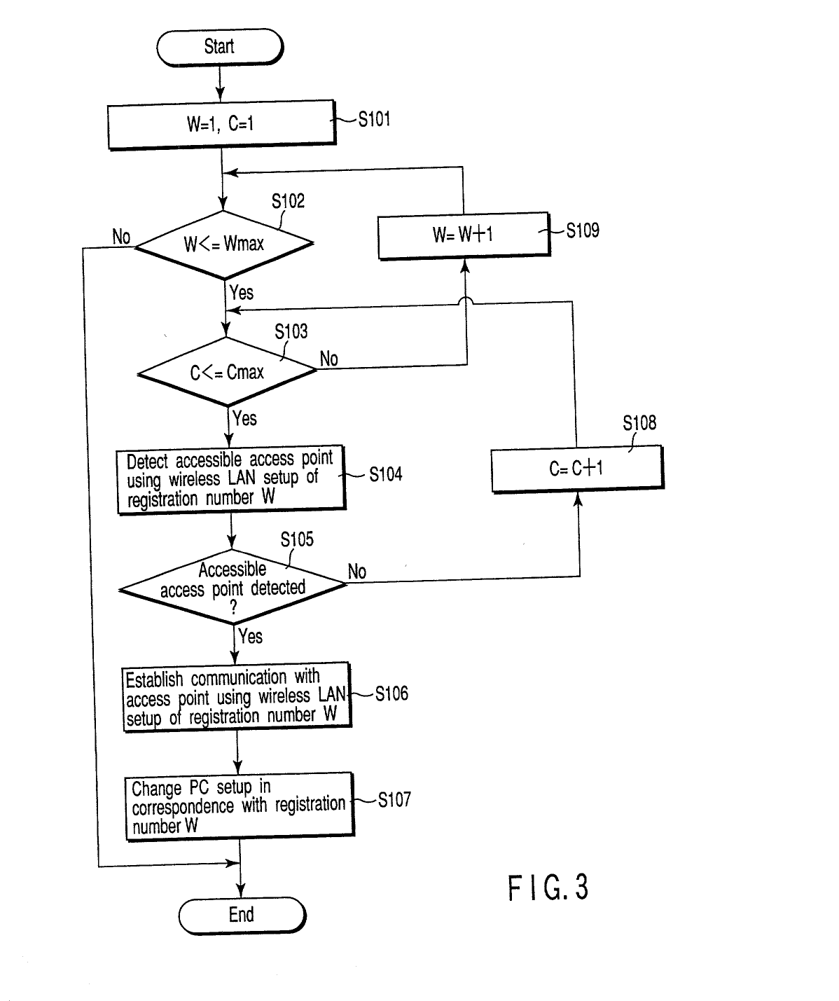

FIG. 3 is a flow chart showing a network detection process according to the present invention.

The access point detection procedure upon using the mobile PC 1 at the office will be explained below using FIG. 3.

The mobile PC 1 registers a plurality of access point setups, which are assigned priority levels. The mobile PC 1 according to the present invention attempts to detect in descending order of priority level if an access point with which it can communicate is present.

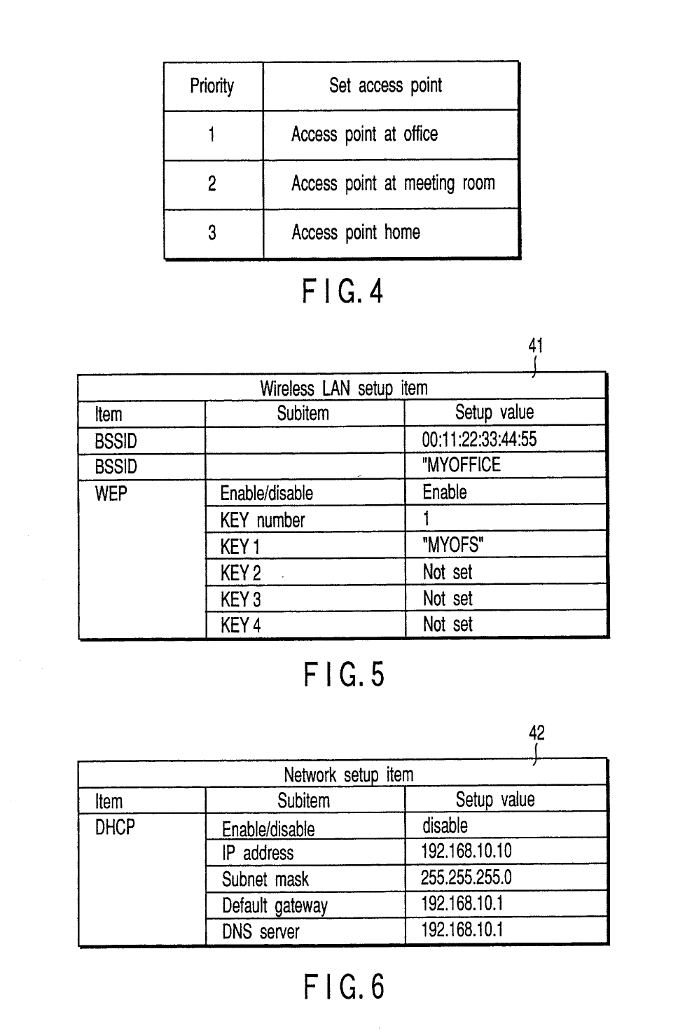

FIG. 4 shows a list of access points that the mobile PC 1 stores. In this list, as the priority order that the mobile PC detects the access point in this example, the access point 23 equipped at the office is given the first priority, and the access point 24 at the meeting room and the access point 32 are given the second and third priority levels, respectively. The mobile PC 1 attempts to detect an accessible access point on the basis of this priority order.

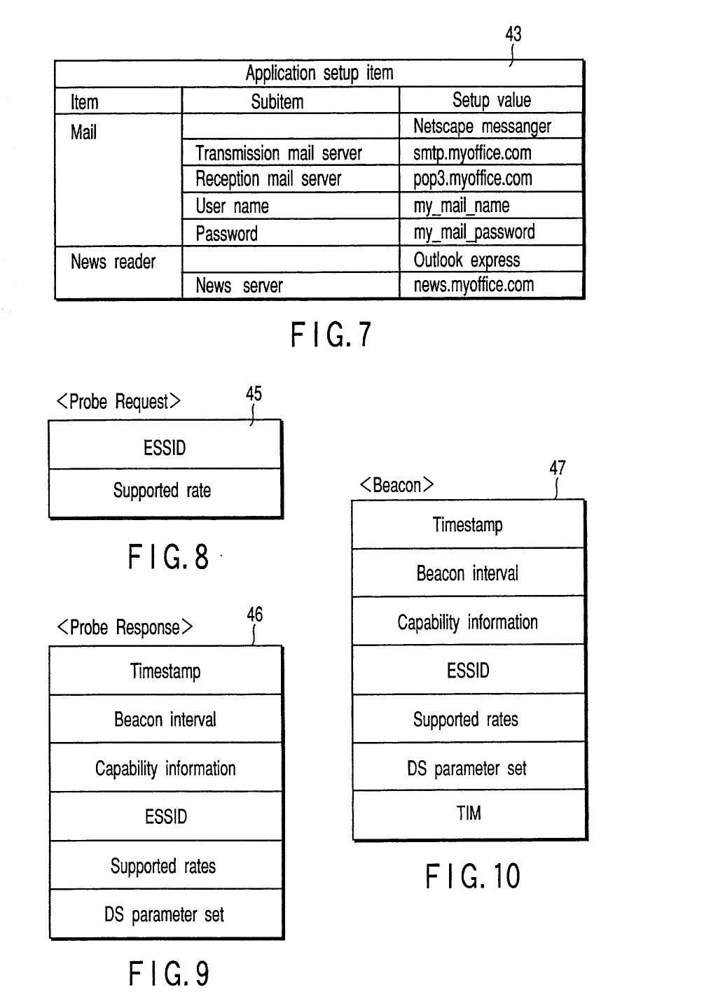

FIG. 5 shows a wireless LAN setup item list in accordance with the access point, FIG. 6 shows a network setup item list in accordance with the access point, and FIG. 7 shows an application setup item list in accordance with the network. FIG. 5 shows a connection setup used upon issuing a connection request, and FIGS. 6 and 7 show communication setups used to make a communication after an authentication process. These setups are lists set for each access point, and the setups shown in FIGS. 5 to 7 are those corresponding to the access point 23. The mobile PC 1 detects an access point and establishes communication setups with the detected access point on the basis of these setups. Also, the setups shown in FIGS. 5 to 7 may be stored in the main memory 4 in the mobile PC 1.

A wireless LAN setup item 41 shown in FIG. 5 includes three items, i.e., BSSID (Basic Service Set ID), ESSID (Extended Service ID), and WEP (Wired Equivalent Privacy).

BSSID is a MAC address unique to each wireless LAN access point, and a partner device is normally discriminated using this value as an identifier.

ESSID is used to identify a connection group of a wireless LAN, and when a network setup and application are to be commonly used across a plurality of access points, the plurality of access points can be managed using identical ESSID. For example, when the access points 23 and 24 are managed using identical ESSID in the company, if the mobile PC 1 has established connection with either access point, it can communicate with the access point 23 or 24 by a roaming process without any special setup change.

WEP is a setup which is used to deny connection from wireless devices other than those having identical WEP codes using a 40-bit encrypted code, and sets information of this WEP code.

In a network setup item 42 shown in FIG. 6, an IP address is set depending on whether DHCP (Dynamic Host Configuration Protocol) is enabled or disabled. Setup items other than “enable/disable DHCP” can be used only when DHCP is disabled. When DHCP is enabled, since an IP address is dynamically assigned to a connected device, this setup is not necessary.

In an application setup item 43 shown in FIG. 7, applications such as mail software, mail server, and the like to be used are automatically set. These applications are registered as defaults after the access point is detected.

The access point detection process sequence will be explained below using FIG. 3.

A priority coefficient “WI” is set to be “1” so as to detect if the mobile PC can communicate with an access point of those registered in the list shown in FIG. 4 in descending order of priority level. Also, an attempt is made to detect a channel in ascending order from channel number =“1”, and channel number “C” to be detected is set to be “1” (step S101).

It is checked if parameter “W” is equal to or smaller than “Wmax” as the number of registered access points (step S102). If no access point is registered, “Wmax=0” (NO in step S102), and the processing ends.

In this example, since three access points are registered, “Wmax=3”. For this reason, since “W” is equal to or smaller than “Wmax” (YES in step S102), it is then checked if the channel number is equal to or smaller than the maximum number of channels (step S103). In this case, the maximum number “Cmax” of channels is 14, and if channel number “C” is equal to or smaller than the maximum number of channels (YES in step S103), an attempt is made to detect an accessible access point in a wireless LAN setup (setup information shown in FIG. 5) including channel number “C” and priority order “W” (currently W=1) (step S104).

As a detection method of an access point, the mobile PC 1 broadcasts a Probe request packet 45 shown in FIG. 8. The Probe request packet 45 contains ESSID of a network group with which the mobile PC 1 tries to establish connection, and communication rate information, and ESSID based on the network setup shown in FIG. 5 is sent as the Probe request packet 45.

Upon receiving the Probe request packet 45, the access point reads information of the Probe request packet 45, and sends a Probe response packet 46 shown in FIG. 9 to the mobile PC 1, if its network ID matches ESSID described in the Probe request packet. FIG. 9 shows the packet structure of the Probe response packet.

This Probe response packet contains information such as a time stamp, a transmission interval of a packet called a Beacon frame, which is periodically sent from the access point, ESSID, and the like. Also, BSSID information of this access point is described in the header of the Probe response packet.

The Beacon frame has a packet structure shown in FIG. 10, and is normally sent from the access point at a given time interval. The Beacon frame contains information such as network status, Beacon interval, ESSID, and the like, and the mobile PC 1 determines if it can communicate with the access point by checking if it can receive the Beacon frame.

As an example, assume that the access point 23 receives the Probe request packet 45 from the mobile PC 1, and ESSID described in the Probe request packet 45 matches that of the access point 23. The access point 23 then sends the Probe response packet 46 to the mobile PC 1.

Upon receiving the Probe response packet 46, the mobile PC 1 determines that detection of the access point 23 has succeeded (YES in step S105), and executes an authentication process with the detected access point 23 based on the 802.11b communication protocol (step S106).

Upon completion of the authentication process, it is determined that a communication with the access point 23 is established, and the network setup item 42 shown in FIG. 6 and applications shown in FIG. 7 are set up (step S107).

The setup items corresponding to the access point 23 include network setup items such as an IP address, subnet mask, default gateway, and the like, setup items depending on applications such as a mail address, mail server, and the like to be used, and so forth.

If the mobile PC 1 cannot receive the Probe response packet 46 (NO in step S105), it is determined that there is no access point with which the mobile PC 1 can communicate using channel “C”, and the channel number is incremented by one (step S108). The flow then returns to step S103.

In this case, for example, if channel number “C” has exceeded the maximum number “Cmax” of channels, it is determined that there is no access point with which the mobile PC can communicate using the setup of priority number “W”, and “W” is incremented by one (step S109) to make an attempt to communicate with an access point with the next highest priority on the basis of FIG. 4. The flow then returns to step S102.

The mobile PC 1 repeats the aforementioned process, and makes an attempt to establish a communication with an access point in accordance with the priority order.

The aforementioned process is triggered when the power supply of the mobile PC 1 is turned on, or when a communication with a device with which the mobile PC communicated so far is disabled (due to low field strength of a signal). Furthermore, such communication disabled state includes a case wherein a Beacon frame cannot be received. In such case, the process shown in FIG. 3 is started.

A case will be explained below wherein the mobile PC 1 has established connection with the access point 23 by the aforementioned process, and then moves to the meeting room where the access point 24 is equipped.

Note that two cases may be considered. In one case, the location of the meeting room falls within the communication range of the access point 23 (a Beacon frame from the access point 23 can be received). In the other case, the location of the meeting room falls outside the communication range of the access point 23 (a Beacon frame from the access point 23 cannot be received).

If the meeting room falls within the communication range with the access point 23, the mobile PC 1 can continue the communication using the access point 23.

However, when the meeting room falls outside the communication range with the access point 23, the mobile PC 1 starts a process for detecting another access point (the process shown in FIG. 3) when a communication with the access point 23 cannot be established (when reception of a Beacon frame does not meet predetermined criteria including, but not limited to, a predetermined communication rate, a predetermined interval, or the like) or when the reception signal level (field strength) from the access point becomes lower than a predetermined threshold value.

In this case, since a communication with the access point 23 becomes difficult, an attempt is made to establish a communication with the access point 24 at the meeting room with the second priority shown in FIG. 4.

In this case, after the access point 24 at the meeting room is detected by the aforementioned process, setups (IP address and the like) for the access point 24 are reflected in the mobile PC, thus allowing a communication with the access point 24.

In FIG. 2, the access point 24 is connected to the access point 23 via the bridge 21, and these access points normally belong to an identical LAN environment (a network with identical ESSID). For this reason, the network setups and the like (those shown in FIGS. 6 and 7) are basically the same as those upon establishing connection with the access point 23, and only setups that pertain to connection of a wireless LAN shown in FIG. 5 are changed.

In the example shown in FIG. 2, the access points 24 and 23 are connected via the bridge 21. Alternatively, if these access points are connected via a router in place of the bridge 21, the office and meeting room have different LAN environments, and the network setups such as an IP address and the like are changed. In this case, since the setups shown in FIG. 6 describe those of the IP address and the like, the IP address shown in FIG. 6 and applications shown in FIG. 7 are set up upon establishing a communication with the access point 24.

A case will be examined below wherein the mobile PC 1 moves from the office to home. In this case, the mobile PC 1 fails to establish a communication with the access points 23 and 24 with higher priority levels, and then establishes a communication with an access point equipped at home to set up an IP address and the like. The setups associated with the access point 32 reflect home LAN network setups, and those of an ISP and the like to which the user subscribes personally in place of setups of the IP address, mail software, and the like for the office.

As described above, a conventional wireless communication device continues to detect a pre-set access point even when a communication disabled state has occurred. However, according to the above embodiment, when the mobile PC 1 cannot detect an access point with which it communicated so far, an attempt is made to detect another access point which is registered in advance, and the network setups for that access point can be made.

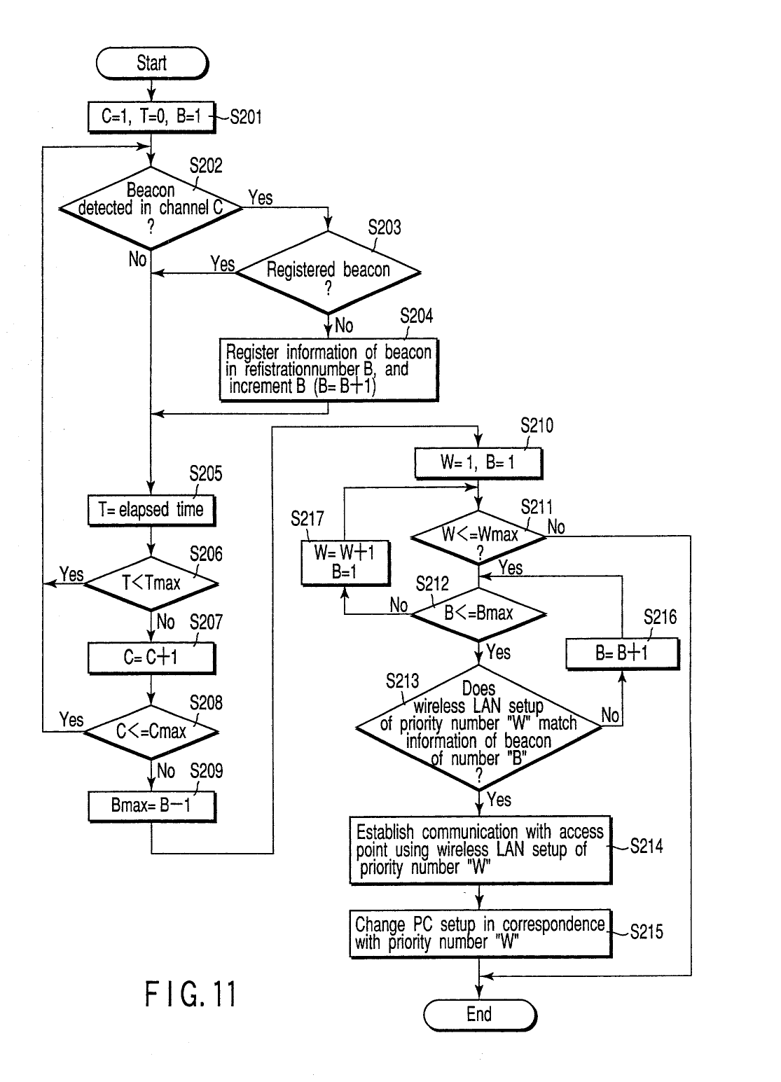

A second embodiment of the access point detection process will be described below with reference to FIG. 11.

FIG. 11 is a flow chart showing a network detection process according to a second embodiment.

In this embodiment, the mobile PC 1 determines an accessible access point by detecting a Beacon frame periodically transmitted from the access point.

As an initial setup, wireless communication channel number “C” is set to be “1”, Beacon monitor time “T” is set to be “0”, and Beacon acquisition number “B” is set to be “1” (step S201).

The aforementioned parameters will be explained below. Channel number “C” is a parameter that determines a wireless communication channel, and scans in turn from channel 1 to the maximum number of channels. Beacon monitor time “T” is a parameter for measuring the Beacon monitor period. Beacon acquisition number “B” is used to count the number of Beacon frames the mobile PC 1 acquired.

A Beacon frame is detected using channel number “C”. If a Beacon frame is detected using channel number “C” (YES in step S202), it is checked if the acquired Beacon frame is an already registered Beacon (step S203).

If the acquired Beacon frame has not been registered yet (NO in step S203), information (BSSID, ESSID) of the acquired Beacon frame and detected channel number “C” are stored as Beacon acquisition number “B”, and Beacon acquisition number “B” is incremented (step S204).

If the acquired Beacon frame is an already registered Beacon (YES in step S203), this Beacon is not stored.

The time elapsed after this process was done is set in Beacon monitor time “T” (step S205), and it is checked if “T” has exceeded predetermined monitor time “Tmax” (step S206).

If “T” has not exceeded monitor time “Tmax” (YES in step S206), the flow returns to step S202 to make an attempt to acquire a Beacon frame again.

If monitor time “Tmax” has been exceeded, channel number “C” is incremented by one (step S207), and it is checked if channel number “C” has exceeded the maximum number “Cmax” of channels (step S208).

If “C” has not exceeded the maximum number “Cmax” of channels, the flow returns to step S202 to detect a Beacon frame.

Upon completion of Beacon frame detection processes using all communication channels (NO in step S208), Beacon acquisition number “B” is set in the total number “Bmax” of acquired Beacons (step S209). In this case, since B has already been incremented in step S204, “B-1” is set in “Bmax”.

Then, it is determined whether or not the acquired Beacon frames are associated with an access point with which the mobile PC 1 can communicate.

An attempt is made to detect the registered access points shown in FIG. 4 in descending order of priority. Priority number “W” is set to be “1”, and Beacon acquisition number “B” is also set to be “1” (step S210).

It is checked if priority number “W” is smaller than the number “Wmax” of registered access point (step S211). If “W” is smaller than “Wmax” (YES in step S211), it is checked if Beacon acquisition number “B” is smaller than the total number “Bmax” of acquired Beacons (step S212).

If the acquisition number is smaller than the total number of acquired Beacons (YES in step S212), the wireless LAN setup items (shown in FIG. 5) of the access point registered in correspondence with priority number “W” are compared with Beacon frame information of Beacon acquisition number “B” (step S213). In one example, whether or not the access point of interest is the registered one is checked by comparing BSSIDs (step S213).

If the Beacon information of Beacon acquisition number “B” matches the information of the access point corresponding to priority number “W” (YES in step S213), an authentication process with the access point is executed based on the 802.11b communication protocol using simultaneously stored channel “C” (step S214).

Upon completion of the authentication process, it is determined that a communication with the access point is established, and the network setup item 42 shown in FIG. 6 and applications shown in FIG. 7 are set up.

On the other hand, if it is determined that the wireless LAN setup of priority number “W” does not match the Beacon information of Beacon acquisition number “B” (NO in step S213), Beacon acquisition number “B” is incremented (B=B+1) to compare it with another stored Beacon information (step S216), and the flow returns to step S212.

If Beacon acquisition number “B” is equal to or larger than the total number “Bmax” of acquired Beacons (NO in step S212), priority number “W” is incremented (W=W+1) to detect the access point with the next highest priority, Beacon acquisition number “B” is set to be “1” (step S217), and it is checked again if the setup of priority number “W” matches information of the acquired Beacon.

If priority number “W” is equal to or larger than the number of registered access points (NO in step S211), it is determined that it is impossible to communicate with the registered access points, and the processing ends.

The process shown in FIG. 11 may be started as a process for detecting a new Beacon frame when a Beacon frame cannot be acquired from the connected access point.

In the above embodiment, the mobile PC acquires a Beacon frame sent from an access point, and compares the acquired Beacon frame with the setup registered in the mobile PC, thus determining a network with which communication connection can be established. In this way, the network can be detected without taking any action from the mobile PC.

As described above, an electronic device and network setup method, which can detect a currently connectable network in accordance with the priority order of wireless network setups which are registered in advance, and can change the connection setup in correspondence with the detected network even when the network environment has changed, is provided.

The present invention is not limited to the aforementioned embodiments within the scope of the invention, and can be widely applied to all electronic devices which establish network connection using wireless communications, e.g., a PDA (Personal Digital Assistants) including a wireless function and the like.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication setup method for an electronic device employing wireless communications, comprising the steps of:
outputting, via wireless communications from the electronic device, a first connection request signal based on a connection setup with a first wireless communication device;
outputting, via wireless communications from the electronic device, a second connection request signal based on a connection setup with a second wireless communication device, when a response signal to the first connection request signal cannot be received; and
establishing wireless communication between the electronic device and the second wireless communication device based on a first communication setup, when a response signal to the second connection request signal is received by the electronic device.

2. A method according to claim 1, wherein the connection setup with the first wireless communication device contains an identifier of the first wireless communication device, and the connection setup with the second wireless communication device contains an identifier of the second wireless communication device.

3. A method according to claim 1, wherein the first communication setup contains IP address setup information of the electronic device and a communication application setup used for communication with the second wireless communication device.

4. A method according to claim 1, wherein when the response signal to the second connection request signal is received by the electronic device, an authentication process is executed with the second wireless communication device via wireless communications.

5. A method according to claim 1, further comprising the steps of:
outputting, via wireless communications from the electronic device, the first connection request signal based on the connection setup with the first wireless communication device when a field strength of a wireless communication signal used in a wireless communication with the second wireless communication device falls below a predetermined threshold value; and
establishing wireless communication between the electronic device and the first wireless communication device based on a second communication setup, when the response signal to the first connection request signal is received by the electronic device.

6. A method according to claim 1, further comprising the steps of:
outputting, via wireless communications from the electronic device, a third connection request signal based on a connection setup with a third wireless communication device when a field strength of a wireless communication signal used in a wireless communication with the second wireless communication device falls below a predetermined threshold value; and
establishing wireless communication between the electronic device and the third wireless communication device based on a third communication setup, when a response signal to the third connection request signal is received by the electronic device.

7. A method according to claim 1, wherein at least one of the connection setup with the first wireless communication device, the connection setup with the second wireless communication device and the first communication setup is stored in a storage device associated with the electronic device.

8. A method according to claim 5, wherein the second communication setup is stored in a storage device associated with the electronic device.

9. A method according to claim 6, wherein at least one of the connection setup with the third wireless communication device and the third communication setup is stored in a storage device associated with the electronic device.

10. A method according to claim 6, wherein the third communication setup is the same as the second communication setup.

11. A communication setup method for an electronic device employing wireless communications, comprising the steps of:
acquiring a beacon frame via wireless communications; and
comparing information of the beacon frame with connection setups of a plurality of wireless communication devices; and
establishing wireless communication with at least one of the plurality of wireless communication devices based on a communication setup, when the information of the beacon frame matches at least one of the connection setups of the plurality of wireless communication devices.

12. A method according to claim 11, wherein the connection setups respectively contain identifiers of the plurality of wireless communication devices.

13. A method according to claim 11, wherein the communication setup contains IP address setup information of the electronic device, and a communication application setup used for communication with the at least one of the plurality of wireless communication devices.

14. A method according to claim 11, wherein the connection setups are stored in a storage device associated with the electronic device.

15. A method according to claim 11, wherein the communication setup is stored in a storage device associated with the electronic device.

16. A communication setup method for an electronic device employing wireless communications, comprising the steps of:
acquiring, via wireless communications, a first beacon frame transmitted by a first wireless communication device and a second beacon frame transmitted by a second wireless communication device;
comparing information of the first beacon frame with a first connection setup of a wireless communication device;
comparing information of the second beacon frame with the first connection setup, when the information of the first beacon frame does not match the first connection setup; and
establishing wireless communication with the second wireless communication device based on a first communication setup, when the information of the second beacon frame matches the first connection setup.

17. A method according to claim 16, wherein the first connection setup contains an identifier of the second wireless communication device.

18. A method according to claim 16, wherein the first communication setup contains IP address setup information of the electronic device, and a communication application setup used for communication with the second wireless communication device.

19. A method according to claim 16, further comprising the steps of:
when a field strength of a wireless communication signal used in a wireless communication with the second wireless communication device falls below a predetermined threshold value,
acquiring the first beacon frame via wireless communications;
comparing the information of the first beacon frame with a second connection setup; and
establishing wireless communication with the first wireless communication device based on a second communication setup, when the information of the first beacon frame matches the second connection setup.

20. A method according to claim 16, further comprising the steps of:
when a field strength of a wireless communication signal used in a wireless communication with the second wireless communication device falls below a predetermined threshold value,
acquiring, via wireless communications, a third beacon frame transmitted by a third wireless communication device;
comparing information of the third beacon frame with a third connection setup; and
establishing wireless communication with the third wireless communication device based on a third communication setup, when the information of the third beacon frame matches the third connection setup.

21. A method according to claim 16, further comprising the steps of:
when reception of the second beacon frame from the second wireless communication device does not meet predetermined criteria,
acquiring the first beacon frame via wireless communications;
comparing the information of the first beacon frame with a second connection setup; and
establishing wireless communication with the first wireless communication device based on a second communication setup, when the information of the first beacon frame matches the second connection setup.

22. A method according to claim 16, further comprising the steps of:
when reception of the second beacon frame from the second wireless communication device does not meet predetermined criteria,
acquiring, via wireless communications, a third beacon frame transmitted by a third wireless communication device;
comparing information of the third beacon frame with a third connection setup; and
establishing wireless communication with the third wireless communication device based on a third communication setup, when the information of the third beacon frame matches the third connection setup.

23. A method according to claim 16, wherein at least one of the first connection setup and the first communication setup are stored in a storage device associated with the electronic device.

24. A method according to claim 19, wherein at least one of the second connection setup and the second communication setup are stored in a storage device associated with the electronic device.

25. A method according to claim 20, wherein at least one of the third connection setup and the third communication setup are stored in a storage device associated with the electronic device.

26. A method according to claim 20, wherein the third communication setup is the same as the second communication setup.

27. A communication setup method for an electronic device employing wireless communications, comprising the steps of:
acquiring a first beacon frame via wireless communications;
comparing information of the first beacon frame with a first connection setup used to establish connection with a first wireless communication device;
comparing the information of the first beacon frame with a second connection setup used to establish connection with a second wireless communication device, when the information of the first beacon frame does not match the first connection setup; and
establishing wireless communication with the second wireless communication device based on a first communication setup, when the information of the first beacon frame matches the second connection setup.

28. A method according to claim 27, wherein the first communication setup contains IP address setup information of the electronic device, and a communication application setup used for communication with the second wireless communication device.

29. A method according to claim 27, further comprising the steps of:
when a field strength of a wireless communication signal used in a wireless communication with the second wireless communication device falls below a predetermined threshold value,
acquiring a second beacon frame via wireless communications, which is different from said first beacon frame;
comparing information of the second beacon frame with the first connection setup; and
establishing wireless communication with the first wireless communication device based on a second communication setup, when the information of the second beacon frame matches the first connection setup.

30. A method according to claim 27, further comprising the steps of:
when a field strength of a wireless communication signal used in a wireless communication with the second wireless communication device falls below a predetermined threshold value,
acquiring a second beacon frame via wireless communications, which is different from said first beacon frame;
comparing information of the second beacon frame with the first connection setup;
comparing the information of the second beacon frame with a third connection setup used to establish connection with a third wireless communication device, when the information of the second beacon frame does not match the first connection setup; and
establishing wireless communication with the third wireless communication device based on a third communication setup, when the information of the second beacon frame matches the third connection setup.

31. A method according to claim 27, further comprising the steps of:
when reception of the first beacon frame from the second wireless communication device does not meet predetermined criteria,
acquiring a second beacon frame via wireless communications, which is different from said first beacon frame;
comparing information of the second beacon frame with the first connection setup; and
establishing wireless communication with the first wireless communication device based on a second communication setup, when the information of the second beacon frame matches the first connection setup.

32. A method according to claim 27, further comprising the steps of:
when reception of the first beacon frame from the second wireless communication device does not meet predetermined criteria,
acquiring a second beacon frame via wireless communications, which is different from said first beacon frame;
comparing information of the second beacon frame with the first connection setup;
comparing the information of the second beacon frame with a third connection setup used to establish connection with a third wireless communication device, when the information of the second beacon frame does not match the first connection setup; and
establishing wireless communication with the third wireless communication device based on a third communication setup, when the information of the second beacon frame matches the third connection setup.

33. An electronic device comprising:
a wireless communication interface for outputting a first connection request signal based on a first connection setup used to establish connection with a first wireless communication device, and for outputting a second connection request signal based on a second connection setup used to establish connection with a second wireless communication device when a response signal to the first connection request signal cannot be received;
wherein when a response signal to the second connection request signal is received via said wireless communication interface, said wireless communication interface establishes communication with the second wireless communication device via said wireless communication interface based on a communication setup.

34. A device according to claim 33, wherein the communication setup contains IP address setup information of the electronic device, and a communication application setup used for communication with the second wireless communication device.

35. A device according to claim 33, wherein the wireless communication interface comprises a controller for determining when a field strength of a wireless communication signal used in a wireless communication with the second wireless communication device falls below a predetermined threshold value, and
wherein when said controller determines that the field strength falls below the predetermined threshold value,
said wireless communication interface outputs a third connection request signal based on a third connection setup used to establish connection with a third wireless communication device, and
wherein when a response signal to the third connection request signal is received,
said wireless communication interface establishes wireless communication with the third wireless communication device based on a second communication setup.

36. A device according to claim 33, further comprising a storage device for storing at least one of the first connection setup, the second connection setup, and the communication setup.

37. An electronic device comprising:
a wireless communication interface for acquiring a first beacon frame transmitted by a first wireless communication device and a second beacon frame transmitted by a second wireless communication device; and
a processor programmed for comparing information of the first beacon frame with a connection setup for establishing connection with a wireless communication device, and for comparing information of the second beacon frame with the connection setup when the information of the first beacon frame does not match the connection setup;
wherein when the information of the second beacon frame matches the connection setup, communication is established with the second wireless communication device based on a communication setup.

38. A device according to claim 37, wherein the communication setup contains IP address setup information of said electronic device, and a communication application setup used for communication with the second wireless communication device.

39. A device according to claim 37, wherein the wireless communication interface comprises a controller for determining when a field strength of a wireless communication signal used in a wireless communication with the second wireless communication device falls below a predetermined threshold value, and
wherein when said controller determines that the field strength falls below the predetermined threshold value,
a third beacon frame transmitted by a third wireless communication device is acquired via said wireless communication interface,
said processor compares information of the third beacon frame with a second connection setup, and
when the information of the third beacon frame matches the second connection setup, establishes communication with the third wireless communication device based on a second communication setup.

40. A device according to claim 37, wherein the wireless communication interface comprises a controller for determining if reception of the second beacon frame from the second wireless communication device does not meet predetermined criteria, and
wherein when said controller determines that reception of the second beacon frame does not meet the predetermined criteria,
a third beacon frame transmitted by a third wireless communication device is acquired via said wireless communication interface,
said processor compares information of the third beacon frame with a second connection setup, and
when the information of the third beacon frame matches the second connection setup, establishes communication with the third wireless communication device based on a second communication setup.

41. An electronic device comprising:
wireless communication interface means for outputting a first connection request signal based on a first connection setup used to establish connection with a first wireless communication device, and for outputting a second connection request signal based on a second connection setup used to establish connection with a second wireless communication device when a response signal to the first connection request signal cannot be received;
wherein when a response signal to the second connection request signal is received via said wireless communication interface means, said wireless communication interface means establishes communication with the second wireless communication device via said wireless communication interface means based on a communication setup.

42. A device according to claim 41, further comprising storage means for storing at least one of the first connection setup, the second connection setup, and the communication setup.

43. A device according to claim 41, wherein the communication setup contains IP address setup information of the electronic device, and a communication application setup used for communication with the second wireless communication device.

44. A device according to claim 41, further comprising means for determining when a field strength of a wireless communication signal used in a wireless communication with the second wireless communication device falls below a predetermined threshold value, and
wherein when said determining means determines that the field strength falls below the predetermined threshold value,
said wireless communication interface means outputs a third connection request signal based on a third connection setup used to establish connection with a third wireless communication device, and
wherein when a response signal to the third connection request signal is received,
said wireless communication interface means establishes wireless communication with the third wireless communication device based on a second communication setup.

45. An electronic device comprising:
wireless communication interface means for acquiring a first beacon frame transmitted by a first wireless communication device and a second beacon frame transmitted by a second wireless communication device; and
comparing means for comparing information of the first beacon frame with a connection setup for establishing connection with a wireless communication device, and for comparing information of the second beacon frame with the connection setup when the information of the first beacon frame does not match the connection setup;
wherein when the information of the second beacon frame matches the connection setup, communication is established with the second wireless communication device based on a communication setup.

46. A device according to claim 45, wherein the communication setup contains IP address setup information of said electronic device, and a communication application setup used for communication with the second wireless communication device.

47. A device according to claim 45, further comprising means for determining when a field strength of a wireless communication signal used in a wireless communication with the second wireless communication device falls below a predetermined threshold value, and
wherein when said determining means determines that the field strength falls below the predetermined threshold value,
a third beacon frame transmitted by a third wireless communication device is acquired via said wireless communication interface means,
said comparing means compares information of the third beacon frame with a second connection setup, and
when the information of the third beacon frame matches the second connection setup, the wireless communication interface means establishes communication with the third wireless communication device based on a second communication setup.

48. A device according to claim 45, further comprising means for determining if reception of the second beacon frame from the second wireless communication device does not meet predetermined criteria, and
wherein when said determining means determines that reception of the second beacon frame does not meet the predetermined criteria,
a third beacon frame transmitted by a third wireless communication device is acquired via said wireless communication interface means,
said comparing means compares information of the third beacon frame with a second connection setup, and
when the information of the third beacon frame matches the second connection setup, the wireless communication interface means establishes communication with the third wireless communication device based on a second communication setup.
